(19) United States
(12) Patent Application Publication
(10) Pub. No.: US 2017/0111883 A1
(43) Pub. Date: Apr. 20, 2017

(54) PAGING TOWARDS MULTIPLE DEVICES IN A GROUP OF DEVICES

(71) Applicant: Telefonaktiebolaget LM Ericsson (publ), Stockholm (SE)

(72) Inventors: Yong Yang, Kållered (SE); Peter Hedman, Helsingborg (SE)

(21) Appl. No.: 14/907,456

(22) PCT Filed: Apr. 7, 2015
(86) PCT No.: PCT/EP2015/057509

§ 371 Date: Jan. 25, 2016

(51) Int. Cl. H04W 68/02; H04W 76/02; H04W 4/08

(52) U.S. Cl. CPC H04W 68/02; H04W 4/08; H04W 76/021

(57) ABSTRACT

This disclosure is directed to a method and a mobility management unit for performing the method of paging a group of wireless terminals served by one or more radio access network nodes. The method comprises. receiving for each wireless terminal in the group of wireless terminals a connection request message; allocating for each wireless terminal in the group of wireless terminals a terminal-identity with a group-identity where the terminal-identity or at least the group-identity is the same or at least partly the same for each wireless terminal; sending to each wireless terminal in the group of wireless terminals, in response to the connection request message, a connection accept message comprising the terminal-identity to enable paging the group of wireless terminals by a single paging message to each radio access network node serving one or more wireless terminals in the group of wireless terminals.

### TECHNICAL FIELD

Exemplifying embodiments presented herein are directed to a mobility management unity configured to operatively page a group of wireless terminals served by one or more radio access network nodes, and a method in a mobility management unity for paging a group of wireless terminals served by one or more radio access network nodes.

### BACKGROUND

In a wireless communications network wireless terminals communicate with one or more Core Networks (CNs) via one or more Radio Access Network(s) (RAN).

The wireless terminals may e.g. be a mobile station (MS) or a user equipment (UE) or similar wireless device, e.g. such as mobile phones, or cellular phones, or laptops or similar devices with wireless capability, and thus can be, for example, portable, pocket, hand-held, computer-comprised, or vehicle-mounted or other wireless devices which communicate voice and/or data with a radio access network. It should be emphasized that the wireless terminals may be embedded (e.g. as a card or a circuit arrangement or similar) in and/or attached to various other devices, e.g. such as various laptop computers or tablets or similar or other mobile consumer electronics or similar, or vehicles or boats or air planes or other movable devices, e.g. intended for transport purposes. Indeed, the radio terminal may even be embedded in and/or attached to various stationary or semi-stationary devices, e.g. domestic appliances or similar, or consumer electronics such as printers or similar having a semi-stationary mobility character.

The Radio Access Network (RAN) covers a geographical area which is divided into cell areas, with each cell area being served by a base station, e.g. a Radio Base Station (RBS). In some radio access networks the base station is e.g. called “NodeB” or “B node” or enhanced NodeB (eNB). A cell is a geographical area where radio coverage is provided by the equipment of a radio base station at a base station site. Each cell is identified by an identity within the local radio area, which may be broadcasted in the cell. The base stations communicate via an air interface with radio terminals within range of the base stations.

In some versions of the RAN, several base stations are typically connected, e.g. by landlines or microwave links, to a Radio Network Controller (RNC) or a Base Station Controller (BSC) or similar. The radio network controller or similar supervises and coordinates various activities of the plural base stations connected thereto. The radio network controllers are typically connected to one or more core networks.

For example, the General Packet Radio Service (GPRS) is a wireless communication system, which evolved from the GSM. The GSM EDGE Radio Access Network (GERAN) is a radio access network for enabling radio terminals to communicate with one or more core networks.

For example, the Universal Mobile Telecommunications System (UMTS) is a third generation wireless communication system, which evolved from the Global System for Mobile Communications (GSM), and is intended to provide improved mobile communication services based on Wideband Code Division Multiple Access (WCDMA) access technology.

Typically the Core Network (CN), to which the wireless terminal communicates via the RAN, comprises a number of core network nodes.

Examples of core network nodes are the Serving Gateway (SGW) and the Policy and Charging Rules Function (PCRF) and the Home Subscriber Server (HSS) and the Serving GPRS Support Node (SGSN).

Another core network node is the network gateway node. The network gateway node provides connectivity for the radio terminals of the communication network to one or more external Packet Data Networks (PDNs). A radio terminal may have simultaneous connectivity with more than one network gateway node for accessing multiple PDNs. The network gateway node may e.g. be a Gateway GPRS Support Node (GGSN) or a PDN Gateway (PGW).

Typically the network gateway provides PDN connectivity by creating a PDN-connection for a radio terminal to a PDN served by the network gateway. The PDN connection may be requested by the radio terminal, e.g. by sending a message to the network gateway, e.g. a PDN Connectivity Request message or similar.

An Access Point Name (APN) is used to identify the PDN to which the PDN-connection is to be created for the radio terminal. Thus, a PDN-connection is a connection for a radio terminal to a PDN identified by an APN. The APN may e.g. be provided to the network gateway by the radio terminal, e.g. in a message, sent when requesting the PDN connection, e.g. a PDN Connectivity Request message or similar. Alternatively the APN may e.g. be known by the network gateway (e.g. predefined in the network gateway) such that the network gateway knows that this APN is to be used for the particular radio terminal.

Thus, the APN identifies the PDN that a radio terminal wants to communicate with. In addition to identifying a PDN, an APN may also be used to define the type of service—e.g. connection to wireless application protocol (WAP) server, multimedia messaging service (MMS)—that is provided by the PDN. APN is e.g. used in 3GPP data access networks, e.g. the above mentioned GPRS and/or in the Evolved Packet Core (EPC).

FIG. 1 shows a schematic overview of a well-known exemplifying wireless communication system. The system is a so called LTE based system. It should be pointed out that the terms “LTE” and “LTE based” system is here used to comprise both present and future LTE based systems, such as, for example, advanced LTE systems.

It should be appreciated that although FIG. 1 shows a wireless communication system in the form of a LTE based system, the example embodiments herein may also be utilized in connection with other wireless communication systems comprising nodes and functions that correspond to the nodes and functions of the system in FIG. 1.

In FIG. 1 the E-UTRAN corresponds to the Radio Access Network (RAN), which in this case comprises a number of radio access node in the form of eNodeBs (eNB) that interfaces with a wireless terminal, which is denoted User Equipment (UE) in LTE. Several UEs are normally served by one eNB. However, for the sake of simplicity only one UE is illustrated in FIG. 1.

The Serving Gateway (SGW) routes and forwards user data packets, while also acting as the mobility anchor for the user plane during inter-eNB handovers and as the anchor for mobility between LTE and other 3GPP technologies (terminating S4 interface and relaying the traffic between 2G/3G systems and PDN GW). For idle state UEs, the SGW terminates the DL data path and triggers paging when DL data arrives for the UE. It manages and stores UE contexts, e.g. parameters of the IP bearer service, network internal routing information. It also performs replication of the user traffic in case of lawful interception.

The Mobility Management Entity (MME) is the key control-node for the LTE access-network. It is responsible for idle mode UE tracking and paging procedure including retransmissions. It is involved in the bearer activation/deactivation process and is also responsible for choosing the SGW for a UE at the initial attach and at time of intra-LTE handover involving Core Network (CN) node relocation. It is responsible for authenticating the user (by interacting with the HSS). The Non-Access Stratum (NAS) signaling terminates at the MME and it is also responsible for generation and allocation of temporary identities to UEs. It checks the authorization of the UE to camp on the service provider's Public Land Mobile Network (PLMN) and enforces UE roaming restrictions. The MME is the termination point in the network for ciphering/integrity protection for NAS signaling and handles the security key management. Lawful interception of signaling is also supported by the MME. The MME also provides the control plane function for mobility between LTE and 2G/3G access networks with the S3 interface terminating at the MME from the SGSN. The MME also terminates the S6a interface towards the home HSS for roaming UEs

The PDN Gateway (PGW) is a network gateway node that provides connectivity for the UE to one or more external Packet Data Networks (PDNs) 250 by being the point of exit and entry of traffic for the UE. A UE may have simultaneous connectivity with more than one PGW for accessing multiple PDNs. The PGW performs policy enforcement, packet filtering for each user, charging support, lawful Interception and packet screening. Another key role of the PGW is to act as the anchor for mobility between 3GPP and non-3GPP technologies such as WiMAX and 3GPP2 (CDMA 1× and EvDO).

The Policy and Charging Rules Function (PCRF) determines policy rules in real-time with respect to the radio terminals of the system. This may e.g. include aggregating information in real-time to and from the core network and operational support systems etc of the system so as to support the creation of rules and/or automatically making policy decisions for user radio terminals currently active in the system based on such rules or similar. The PCRF provides the PGW with such rules and/or policies or similar to be used by the PGW acting as a Policy and Charging Enforcement Function (PCEF).

The Home Subscriber Server (HSS) is a database that contains user-related and subscriber-related information. It also provides support functions in mobility management, call and session setup, user authentication and access authorization.

FIG. 2 shows a schematic overview of another exemplifying wireless communication system. The system is a well-known exemplifying GPRS architecture.

The Gateway GPRS Support Node (GGSN) is a network gateway node that provides connectivity for radio terminals such as UEs or MSs to one or more external Packet Data Networks (PDNs) 250 by being the point of exit and entry of traffic for the radio terminal. The GGSN is a main component of the GPRS network. The GGSN is responsible for the interworking between the GPRS network and one or more external Packet Data Networks (PDNs) 250, e.g. like the Internet and X.25 networks. The GGSN is the anchor point that enables the mobility of the user terminal in the GPRS/UMTS networks and it may be seen as the GPRS equivalent to the Home Agent in Mobile IP. It maintains routing necessary to tunnel the Protocol Data Units (PDUs) to the SGSN that services a particular Mobile Station (MS). The GGSN converts the GPRS packets coming from the SGSN into the appropriate packet data protocol (PDP) format (e.g., IP or X.25) and sends them out on the corresponding packet data network. In the other direction, PDP addresses of incoming data packets are converted to the GSM address of the destination user. The readdressed packets are sent to the responsible SGSN. The GGSN is responsible for IP address assignment and is the default router for the connected user equipment (UE). The GGSN also performs authentication and charging functions. Other functions include subscriber screening, IP Pool management and address mapping, QoS and PDP context enforcement.

The Serving GPRS Support Node (SGSN) is responsible for the delivery of data packets from and to the radio terminals such as mobile stations within its geographical service area. Its tasks include packet routing and transfer, mobility management (attach/detach and location management), logical link management, and authentication and charging functions. The location register of the SGSN stores location information (e.g., current cell, current Visitor Location Register (VLR)) and user profiles (e.g., International Mobile Station Identity (IMSI), address(es) used in the packet data network) of all GPRS users registered with this SGSN.

The nodes and units of the wireless communication system in FIG. 1 and FIG. 2 are connected by lines extending between the nodes and units. Each such line is marked with a label, which corresponds to the name used in the 3GPP specifications for the particular interface. This is well known to those skilled in the art and it needs no further explanation.

It should be appreciated that although FIG. 1 shows a wireless communications system in the form of an exemplifying LTE based system and FIG. 2 shows a wireless communications system in the form of an exemplifying GPRS architecture, the example embodiments herein may also be utilized in connection with other wireless communication systems comprising nodes and functions that correspond to the nodes and functions of the system in FIG. 1.

FIG. 6 is a schematic illustration of the structure of the well-known International Mobile Subscriber Identity (IMSI). An IMSI shall be uniquely allocated to each mobile subscriber in every 3GPP system. An IMSI is composed of three parts, as shown in FIG. 6: 1) Mobile Country Code (MCC) consisting of three digits. The MSS identifies uniquely the country of domicile of mobile subscriber; 2) Mobile Network Code (MNC) consisting of two or three digits for GSM/UMTS applications that identifies the home PLMN of the mobile subscriber. The length of the MNC (two or three digits) depends on the value of the MCC; 3) Mobile Subscriber Identification Number (MSIN) identifying the mobile subscriber within a PLMN. In FIG. 6 there is also shown a National Mobile Subscriber Identity (NMSI) consisting of the MNC and the NMSI.

FIG. 7 is a schematic illustration of the structure of the well-known Globally Unique Temporary UE Identity (GUTI). The purpose of the GUTI is to provide an unambiguous identification of the UE that does not reveal the UE or the user's permanent identity in the Evolved Packet System (EPS). It also allows the identification of the MME and the network. It can be used by network and the UE to establish UE's identity during signaling between them in EPS. In case a SGSN (including Gn/Gp SGSN and S4-SGSN) is used instead of the MME, then the term corresponding to GUTI is P-TMSI.

In case the alternative is not limited to the MME, the SGSN (including Gn/Gp SGSN and S4-SGSN), the term corresponding to GUTI is P-TMSI.

A GUTI consist two main components:
Globally Unique MME Identity (GUMMEI)—that uniquely identifies the MME which allocated the GUTI.
MME Temporary Mobile Subscriber Identity (M-TMSI)—that uniquely identifies the UE within the MME that allocated the GUTI. The SAE Temporary Mobile Subscriber Identity (S-TMSI) comprises the MME code and the M-TMSI.

The format and size of the GUTI is: GUTI=GUMMEI+M-TMSI, where GUMMEI=Mobile Country Code (MCC)+Mobile Network Code (MNC)+MME Identifier (=MME Group ID+MME Code). The MCC and the MNC shall have the same field size as in earlier 3GPP systems. M-TMSI shall be of 32 bits length. MME Group ID shall be of 16 bits length. MME Code shall be of 8 bits length.

FIG. 3 shows a schematic overview of a well-known exemplifying architecture for Machine-Type Communications. Machine Type Communication (MTC)—also called Machine-to-Machine (M2M) communication—means communication between machines. Communication between machines may e.g. occur in connection with telematics, security, automation meter reading, payment, vending machines. Currently, smart grid and automated metering are some strong driving forces behind implementation of MCT. However, other fields such as the connected home, healthcare applications and support for devices and application in connection with vehicles and transportation are also interesting use-cases.

Several nodes and functions in the exemplifying architecture for Machine-Type Communications shown in FIG. 3 have already been described above with reference to FIGS. 1 and 2. The additional nodes and functions that are shown in FIG. 3 are well known to those skilled in the art, but for the sake of clarity they will be briefly explained below.

The Application Server (AS) hosts the MTC application in the external network. The As may make use of an SCSF for additional value-added services. A corresponding MTC application is typically hosted by the wireless terminals communicating with an AS.

The Service Capability Server Function (SCSF) is the entity that connects the MTC application domain to the network domain. It provides the MTC application with an endpoint for communications with a wireless device in networks e.g. such as the exemplifying wireless communication system shown in FIGS. 1 and 2 or similar.

The Machine Type Communication Inter Working Function (MTC-IWF) is an interworking function between the external application server and the core network of a wireless communication system, e.g. such as the exemplifying wireless communication system shown in FIGS. 1 and 2 or similar. The MTC-IWF relays/translates signaling messages/protocols used over the Tsp interface. Typically the MTC-IWF implements various functions. Usually, the main functions are: 1) authenticate connection requests from the SCSF to the core network of the wireless communication network; 2) authenticate control plane request signals; 3) relaying trigger requests from the SCSF to the.

The exemplifying architecture for MTC in FIG. 3 may e.g. page a group of UEs in the following schematic manner, reflecting known MTC paging procedures as schematically illustrated in FIG. 8:
801. The that AS hosts the MTC application has DL data for a group of UEs, preferably configured with a corresponding MTC application,
802. The AS sends a message to the MTC-IWF/SCEF requesting a trigger of the group of UEs,
803. The MTC-IWF/SCSF interworks with the HSS to get a list of MMEs with which the group of UEs is associated,
804. The MTC-IWF/SCSF sends a Trigger Request per MME,
805. The MME(s) page all the UEs in the group of UEs.

Here, the MME has to send one paging message for each UE in the group of UEs to each eNB that serves or potentially serves the particular UE. This can easily amount to a large number of paging messages, especially since there may be many UEs in a group of UEs and since each of these UEs may be served or potentially served by several eNBs.

Such signaling for every UE can result in a very high signaling load, especially in the control-plane. For that reason, a more lightweight signaling procedure for paging the UEs in a group of UEs is desired to reduce the signaling load that is imposed to the wireless communications network.

### Further Background:

FIG. 11 shows a well-known attach procedure from 3GPP TS 23.401 V13.2.0 (2015-03) clause 5.3.2.1 FIG. 5.3.2.1-1.

FIG. 12 shows a well-known network triggered service request procedure from 3GPP TS 23.401 V13.2.0 (2015-03) clause 5.3.4.3 FIG. 5.3.4.3-1. The paging message comprising the UE paging Identity is sent by the MME and is used to page a UE in one or several tracking areas. Message direction: MME to eNB. The excerpt below is from 3GPP TS 36.413.

### Clause 9.1.6 Paging

| | | | | IE type | | | |
|---|---|---|---|---|---|---|---|
| | | | | and | Semantics | | Assigned |
| IE/Group Name | | Presence | Range | reference | description | Criticality | Criticality |
| Message Type | | M | | 9.2.1.1 | | YES | ignore |
| UE Identity Index value | | M | | 9.2.3.10 | | YES | ignore |
| UE Paging Identity | | M | | 9.2.3.13 | | YES | ignore |
| Paging DRX | | O | | 9.2.1.16 | | YES | ignore |
| CN Domain | | M | | 9.2.3.22 | | YES | ignore |
| List of TAIs | | | 1 | | | YES | ignore |
| | >TAI List Item | | 1 . . . <maxnoofTAIs> | | | EACH | ignore |

| | | | |
|---|---|---|---|
| >>TAI | M | 9.2.3.16 | — |

| CSG Id List | | 0 . . . 1 | | GLOBAL | ignore |
|---|---|---|---|---|---|
| | >CSG Id | 1 . . . <maxnoofCSGId> | 9.2.1.62 | — | |

| | | | | |
|---|---|---|---|---|
| Paging Priority | O | 9.2.1.78 | YES | ignore |
| UE Radio Capability for | O | 9.2.1.98 | YES | ignore |
| Paging | | | | |

### Clause 9.2.3.13 UE Paging Identity

This IE represents the Identity with which the UE is paged.

| | | | IE type | |
|---|---|---|---|---|
| | | | and | Semantics |
| IE/Group Name | Presence | Range | reference | description |
| CHOICE UE Paging | | | | |
| Identity | | | | |
| >S-TMSI | | | | |
| >>S-TMSI | M | | 9.2.3.6 | |
| >IMSI | | | | |
| >>IMSI | M | | 9.2.3.11 | |

FIG. 13 shows a well-known UE triggered service request procedure from 3GPP TS 23.401 V13.2.0 (2015-03) clause 5.3.4.1 FIG. 5.3.4.1-1. The Initial UE message comprising S-TMSI is sent by the eNB to the MME. This message is sent by the eNB to transfer the initial layer 3 message to the MME over the S1 interface. Message direction: eNB to MME. The excerpt below is from 3GPP TS 36.413

### Clause 9.1.7.1 Initial UE Message

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | 9.2.1.1 | | YES | ignore |
| eNB UE S1AP ID | M | 9.2.3.4 | | YES | reject |
| NAS-PDU | M | 9.2.3.5 | | YES | reject |
| TAI | M | 9.2.3.16 | Indicating the | YES | reject |
| | | | Tracking Area from | | |
| | | | which the UE has | | |
| | | | sent the NAS | | |
| | | | message. | | |
| E-UTRAN CGI | M | 9.2.1.38 | Indicating the E- | YES | ignore |
| | | | UTRAN CGI from | | |
| | | | which the UE has | | |
| | | | sent the NAS | | |
| | | | message. | | |
| RRC Establishment | M | 9.2.1.3a | | YES | Ignore |
| Cause | | | | | |
| S-TMSI | O | 9.2.3.6 | | YES | reject |
| CSG Id | O | 9.2.1.62 | | YES | reject |
| GUMMEI | O | 9.2.3.9 | | YES | reject |
| Cell Access Mode | O | 9.2.1.74 | | YES | reject |
| GW Transport Layer | O | Transport | Indicating GW | YES | ignore |
| Address | | Layer | Transport Layer | | |
| | | Address | Address if the GW | | |
| | | 9.2.2.1 | is collocated with | | |
| | | | eNB. | | |
| Relay Node Indicator | O | 9.2.1.79 | Indicating a relay | YES | reject |
| | | | node. | | |
| GUMMEI Type | O | ENUMERATED | | YES | ignore |
| | | (native, | | | |
| | | mapped, . . .) | | | |
| Tunnel Information for | O | Tunnel | Indicating HeNB's | YES | ignore |
| BBF | | Information | Local IP Address | | |
| | | 9.2.2.3 | assigned by the | | |
| | | | broadband access | | |
| | | | provider, UDP port | | |
| | | | Number. | | |
| SIPTO L-GW Transport | O | Transport | Indicating SIPTO L- | YES | ignore |
| Layer Address | | Layer | GW Transport | | |
| | | Address | Layer Address if | | |
| | | 9.2.2.1 | the SIPTO L-GW is | | |
| | | | collocated with | | |
| | | | eNB. | | |
| LHN ID | O | 9.2.1.92 | | YES | ignore |

### SUMMARY

In view of the above there seems to be a need for an improved method for paging a group of wireless devices.

Some of the drawback indicated above are mitigated or eliminated by an embodiment of the present solution directed to a method for paging a group of wireless terminals served by one or more radio access network nodes. The method is performed by a mobility management unit and comprises:
receiving for each wireless terminal in the group of wireless terminals a connection request message,
allocating for each wireless terminal in the group of wireless terminals a terminal identity with a group identity where the terminal identity or at least the group identity is the same or at least partly the same for each wireless terminal,
sending to each wireless terminal in the group of wireless terminals, in response to the connection request message, a connection accept message comprising the terminal identity to enable paging the group of wireless terminals by a single paging message to each radio access network node serving one or more wireless terminals in the group of wireless terminals

Some of the drawback indicated above are mitigated or eliminated by an embodiment of the present solution directed to a method for receiving paging of a group of wireless terminals served by a radio access network node. The method is performed by a wireless terminal of the group of wireless terminals and comprises:
sending a connection request message,
receiving, in response to the connection request message, a connection accept message comprising a terminal identity with a group identity where the group identity has a part that is the same for all wireless terminals in the group of wireless terminals and a part that is unique for each wireless terminal in the group of wireless terminals.

Some of the drawback indicated above are also mitigated or eliminated by an embodiment of the present solution directed to a mobility management unit for paging a group of wireless terminals served by one or more radio access network nodes. The mobility management unit comprises a memory with instructions, and a processor configured to operatively execute the instructions to:
receive for each wireless terminal in the group of wireless terminals a connection request message,
allocate for each wireless terminal in the group of wireless terminals a terminal identity with a group identity where the terminal identity or at least the group identity is the same or at least partly the same for each wireless terminal,
send to each wireless terminal in the group of wireless terminals, in response to the connection request message, a connection accept message comprising the terminal identity to enable paging the group of wireless terminals by a single paging message to each radio access network node serving one or more wireless terminals in the group of wireless terminals.

Some of the drawback indicated above are also mitigated or eliminated by an embodiment of the present solution directed to a wireless terminal for receiving paging of a group of wireless terminals served by a radio access network node. The wireless terminal comprises a memory with instructions, and a processor configured to operatively execute the instructions to:
send a connection request message,
receive, in response to the connection request message, a connection accept message comprising a terminal-identity with a group-identity where the group-identity has a part that is the same for all wireless terminals in the group of wireless terminals and a part that is unique for each wireless terminal in the group of wireless terminals.

It is noted that the solution described herein, with reference to exemplifying embodiments, relates to all possible combinations of features recited in the claims. Further features of, and advantages with, the present solution will become apparent when studying the appended claims and the following description. Those skilled in the art realize that different features of the present solution can be combined to create embodiments other than those described in the following.

### BRIEF DESCRIPTION OF THE DRAWINGS

The foregoing will be apparent from the following more particular description of the exemplifying embodiments, as illustrated in the accompanying drawings in which like reference characters refer to the same parts throughout the different views.

FIG. 1 is a schematic illustration of a well-known exemplifying LTE architecture for 3GPP accesses within an Evolved Packet System (EPS),

FIG. 2 is a schematic illustration of a well-known exemplifying GPRS architecture based on S4 interface;

FIG. 3 is a schematic overview of a well-known exemplifying architecture for Machine-Type Communications,

FIG. 4 is a signaling diagram depicting the operation of a first exemplifying embodiment of a method for paging a group of wireless terminals,

FIG. 5 is a signaling diagram depicting the operation of a second exemplifying embodiment of a method for paging a group of wireless terminals,

FIG. 6 is a schematic illustration of the structure of the well-known International Mobile Subscriber Identity (IMSI),

FIG. 7 is a schematic illustration of the structure of the well-known Globally Unique Temporary UE Identity (GUTI),

FIG. 8 is a schematic illustration of an exemplifying flowchart showing operations of some exemplifying embodiments described herein,

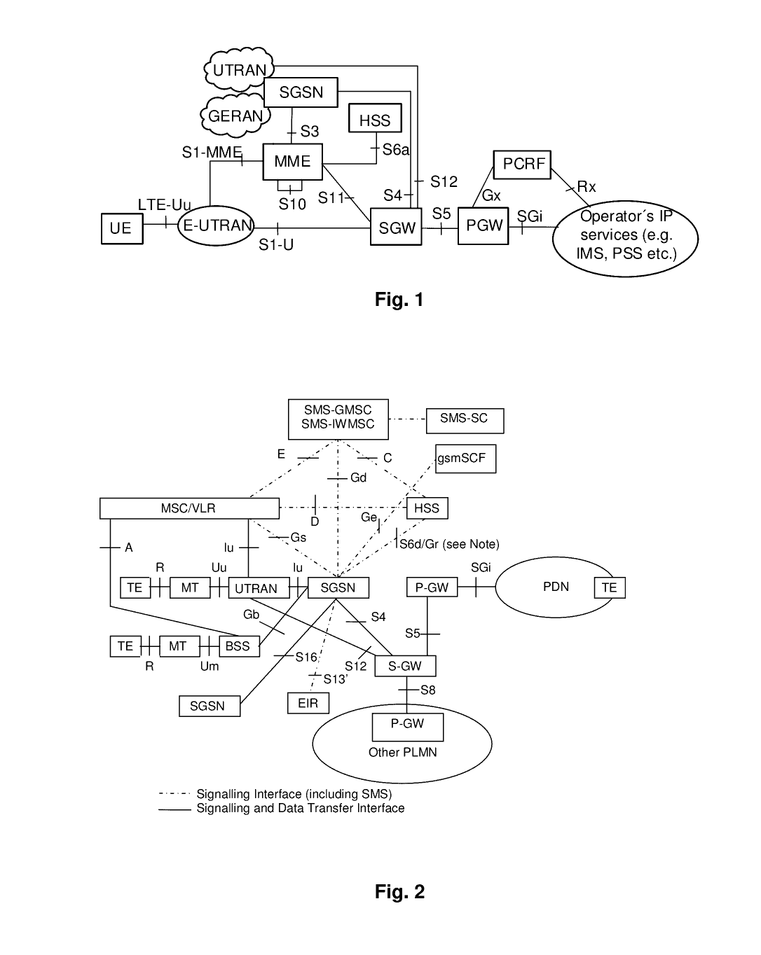

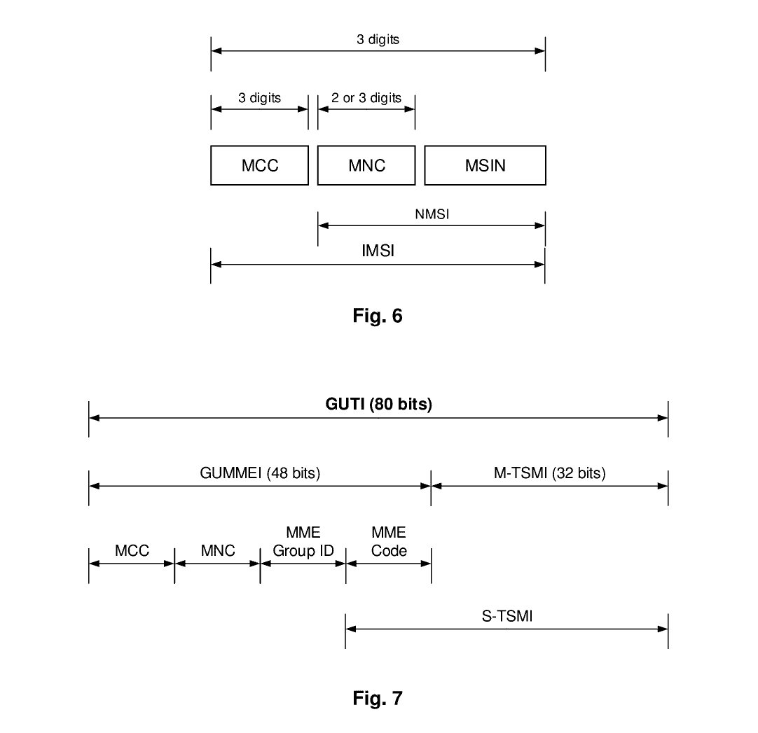

FIG. 7 is a schematic illustration of a signaling diagram depicting the operations of the flow diagram in FIG. 6, now indicating the nodes and messages etc that is involved in the operations,

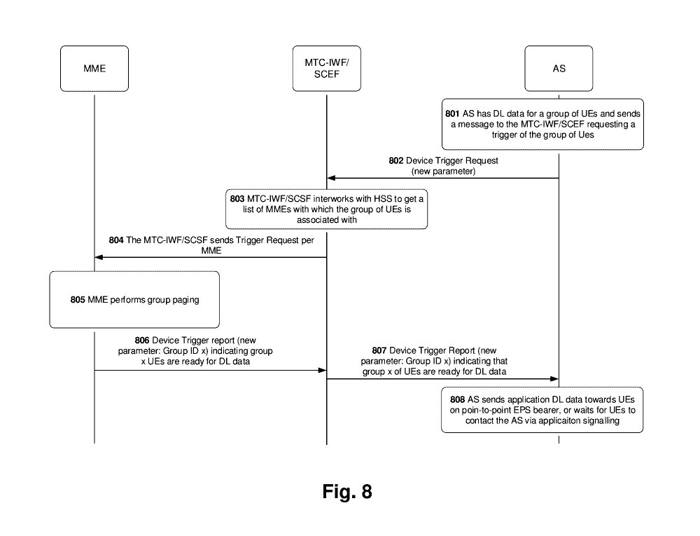

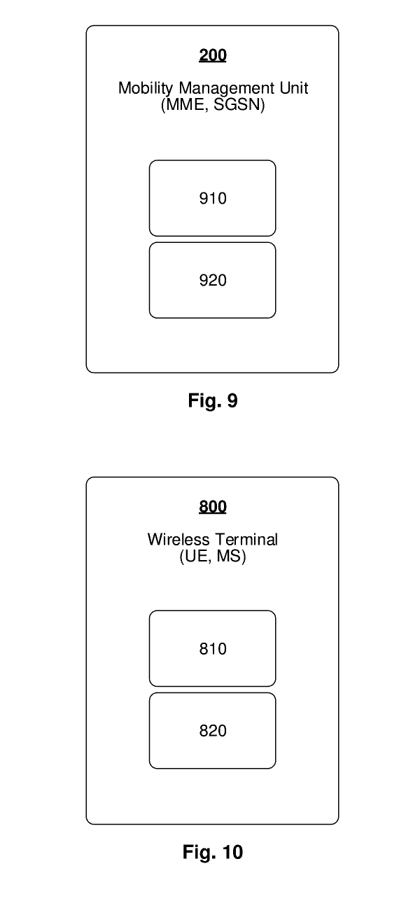

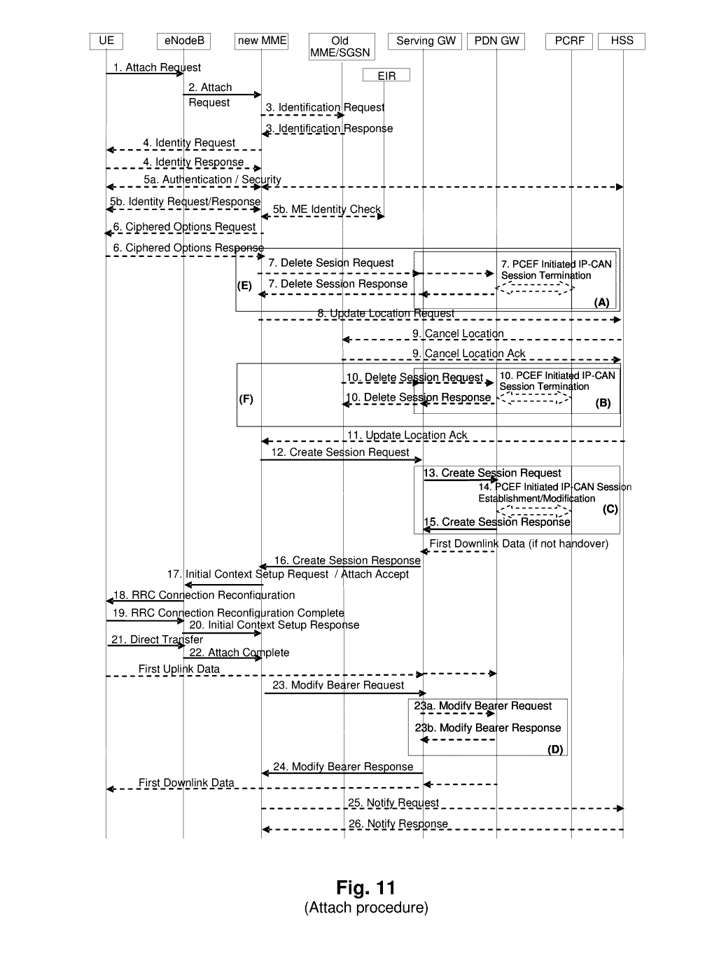

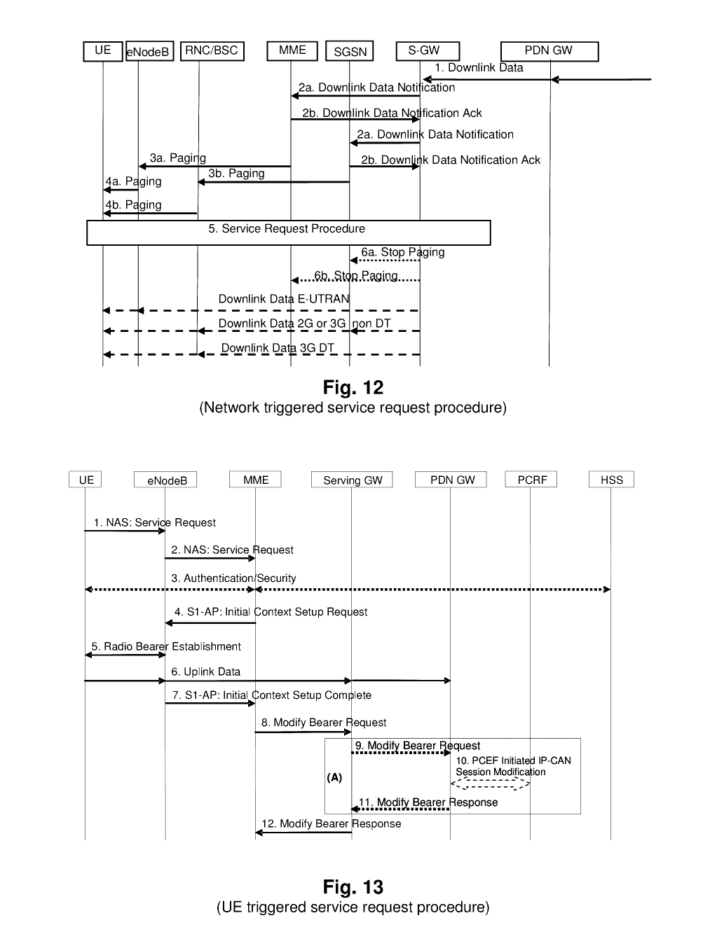

FIG. 8 is a schematic illustration of a known paging procedure in a MTC architecture,

FIG. 9 is a schematic illustration of an exemplifying mobility management unit 200 configured to operatively perform the operations of the exemplifying embodiments described herein,

FIG. 10 is a schematic illustration of an exemplifying wireless terminal 800 configured to operatively perform the operations of the exemplifying embodiments described herein,

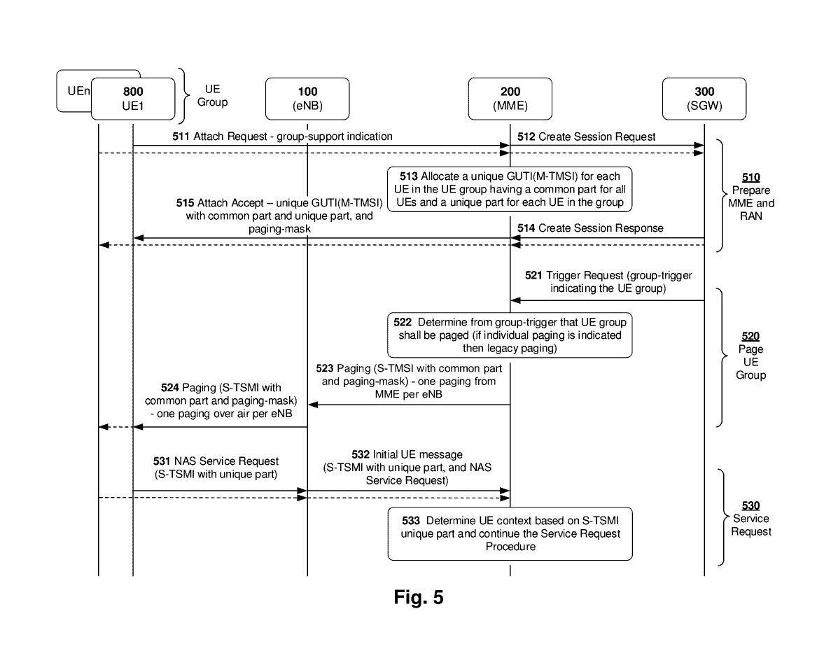

FIG. 11 shows a well-known attach procedure from 3GPP TS 23.401 V13.2.0 (2015-03) clause 5.3.2.1 FIG. 5.3.2.1-1,

FIG. 12 shows a well-known network triggered service request procedure from 3GPP TS 23.401 V13.2.0 (2015-03) clause 5.3.4.3 FIG. 5.3.4.3-1,

FIG. 13 shows a well-known UE triggered service request procedure from 3GPP TS 23.401 V13.2.0 (2015-03) clause 5.3.4.1 FIG. 5.3.4.1-1.

### DETAILED DESCRIPTION

In the following description, for purposes of explanation and not limitation, specific details are set forth, such as particular components, elements, techniques, etc. in order to provide a thorough understanding of the exemplifying embodiments. However, it will be apparent to one skilled in the art that the exemplifying embodiments may be practiced in other manners that depart from these specific details. In other instances, detailed descriptions of well-known methods and elements are omitted so as not to obscure the description of the example embodiments. The terminology used herein is for the purpose of describing the example embodiments and is not intended to limit the embodiments presented herein.

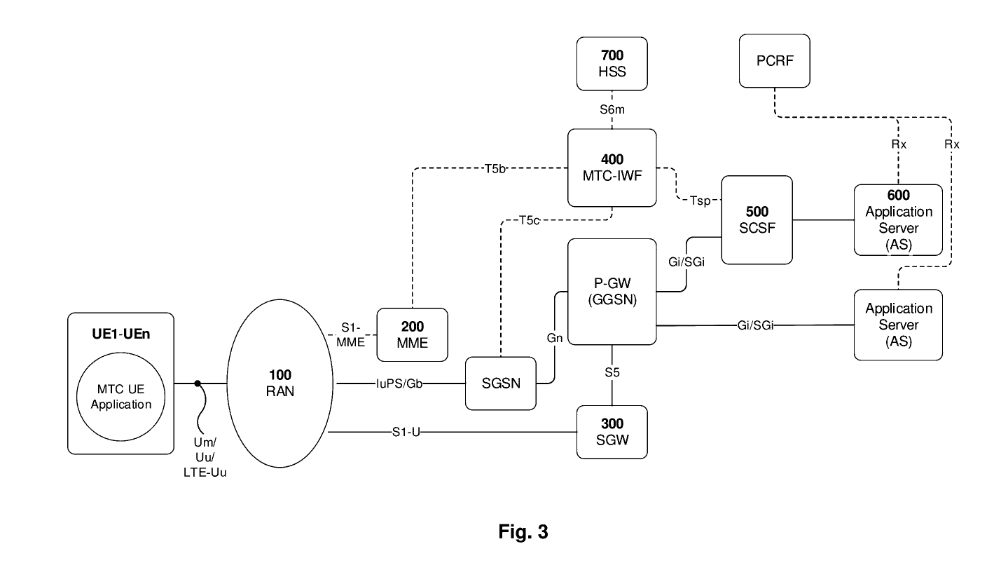

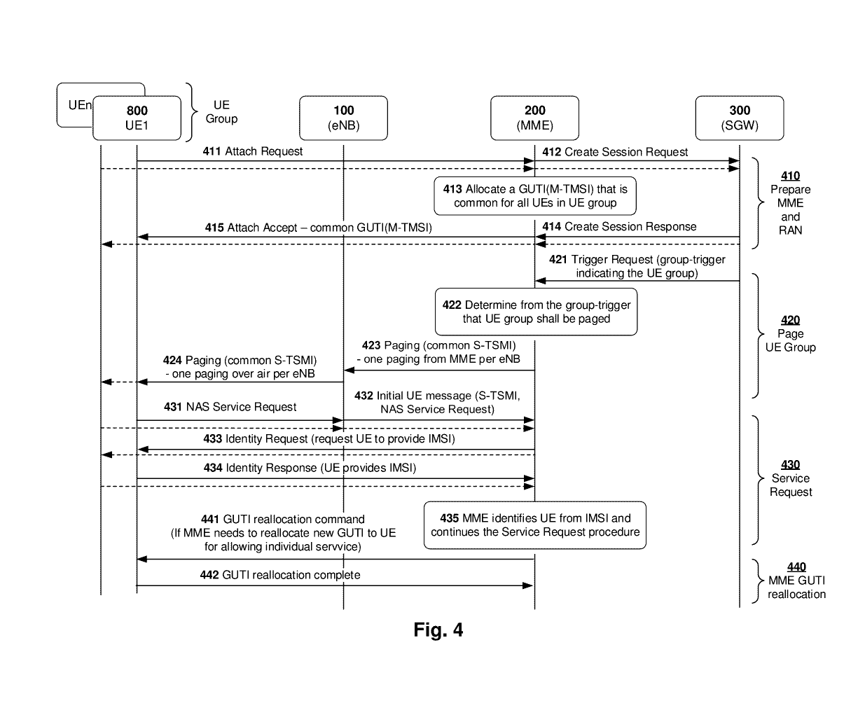

FIG. 4 is a signaling diagram depicting the operation of a first exemplifying embodiment of a method for paging a group of wireless terminals. The method is performed in a mobility management unit operatively configured to perform the paging method in a machine-type architecture, e.g. in the machine-type architecture shown in FIG. 3.

The first exemplifying method is described in some detail below with reference to a mobility management unit in the form of a MME 200, radio access network nodes (RAN nodes) in the form of eNBs and wireless terminals in the form of UEs. In FIG. 4 the group of wireless terminals is a group of UEs comprising UE1 to UEn. Alternatively, the mobility management unit may e.g. be a Serving GPRS Support Node (SGSN) or similar.

As will be further discussed under operation 423, this first exemplifying embodiment has no impact on the UEs in the group of UEs, i.e. the UEs can act as before unaffected of the new paging scheme of this first embodiment.

### Prepare MME and RAN-Nodes—Section 410

### Example Operation 411:

A first exemplifying operation performed in the MME 200 is receiving of a connection request message from each UE1 to UEn in the group of UEs. It is preferred that the connection request message is an attach request message or similar, e.g. an attach request message as specified in 3GPP TS 23.401 V13.2.0 (2015-03) clause 5.3.2 step 2. The connection request message is sent to the ME from the UE in question to register the UE such that the UE can receive services from the core network.

### Example Operation 412:

A second exemplifying operation performed in the MME 200 is sending of a create session request message or similar, preferably to the SGW 300 or similar that is preferably selected by the MME 200. The create session request message may e.g. be a create session request message as specified in 3GPP TS 23.401 V13.2.0 (2015-03) clause 5.3.2 step 12.

### Example Operation 413:

A third exemplifying operation performed in the MME 200 is allocating a terminal-identity for each UE1 to UEn in the group of UEs. Each terminal-identity comprises a group-identity. In some embodiments the whole terminal-identity may be the group-identity, while the group-identity may be a part of the terminal-identity in other embodiments. At least a part of the terminal-identity or at least a part of the group-identity is allocated to be the same for all UEs in the group of UEs.

In this embodiment it is preferred that the terminal-identity is a Globally Unique Temporary Identity (GUTI) comprising a group-identity. It is preferred that the group-identity is a MME Temporary Mobile Subscriber Identity (M-TMSI) or a SAE Temporary Mobile Subscriber Identity (S-TMSI) comprised by the GUTI.

In this embodiment it is preferred that the same common GUTI is allocated for all UEs in the group of UEs. Alternatively, it is preferred that at least the same common S-TMSI and/or at least the same common M-TMSI is allocated for all the UEs in the group of UEs.

For example, the MME 200 may allocate a GUTI with the same common M-TMSI for all UEs in the group of UEs. The GUTI occupies 80 bits and the M-TMSI occupies 32 bits of these 80 bits. The 32 bits of the M-TMSI gives a range from 00 00 00 00 to FF FF FF FF in hexadecimal format. For example, if the MME 200 allocates a M-TMSI comprising FF FF 00 00 for all UEs in the group of UEs, then the MME 200 can use a GUTI with this M-TMSI (FF FF 00 00) to page all the UEs in the group of UEs. Note that the rest of the GUTI is preferably also the same when the MME 200 pages its UEs in the group of UEs, e.g. the same common GUTI that can be allocated in operation 413 above.

Other embodiments may have a GUTI or S-TMSI or M-TMSI with one part that is the same for all UEs in the group of UEs and another part that is unique for each UE in the group of UEs. This will be discussed in more detail below with reference to FIG. 5.

### Example Operation 414:

A fourth exemplifying operation performed in the MME 200 is receiving of a create session response message or similar from the SGW 300 or similar. The create session response message may e.g. be a create session response as specified in 3GPP TS 23.401 V13.2.0 (2015-03) clause 5.3.2 step 16.

### Example Operation 415:

A fifth exemplifying operation performed in the MME 200 is sending a connection accept message to each UE in the group of UEs. The connection accept message is sent in response to the connection request message received for each UE in operation 411. Each connection accept message comprises the terminal-identity that was allocated in the previous operation 413.

As discussed under operation 413 it is preferred that the terminal-identity is a GUTI comprising the group-identity, and that the group-identity correspond to a S-TMSI or M-TMSI or similar comprised by the GUTI.

The connection accept message may be similar to the attach accept message or initial context setup message specified in 3GPP TS 23.401 V13.2.0 (2015-03) clause 5.3.2 step 17, but now comprising the same terminal-identity (e.g. GUTI) or at least the same group-identity (e.g. S-TMSI or M-TMSI) for all UEs in the group of UEs. In other words, this embodiment does not use a unique GUTI for each attaching UE as is the case in clause 5.3.2 step 17.

By providing the same common GUTI or at least the same common S-TMSI or the same common M-TMSI to all UEs in the group of UEs it will be possible for the MME 200 to page the whole group of UEs by simply sending one single paging message to each eNB or similar RAN node that serves one or more UEs in the group of UEs. This saves paging messages, as will be discussed below in connection with operations 423 and 424. This also applies when common terminal-identities are used that are not a GUTI and when common group-identities are used that are not a S-TMSI or a M-TMSI.

### Paging of UE Group—Section 420

### Example Operation 421:

A sixth exemplifying operation performed in the MME 200 is receiving a trigger request message comprising a group-trigger indicating that the particular group of UEs shall be paged.

The trigger request message may be any suitable message received in any suitable manner from any suitable node or unit or function, provided that trigger request message comprises a group-trigger that indicates to the MME 200 that the UEs in a particular group of UEs shall be paged.

However, it is preferred that the trigger request message is a downlink data notification (DDN) message or similar comprising a group-trigger. The DDN message may be received from the SGW 300. The DDN message may be similar to the DDN message defined in 3GPP TS 23.401 V13.2.0 (2015-03) clause 5.3.4.3 step 2a, except that the DDN message of the present embodiment comprises an additional group-trigger indicating to the MME that a particular group of UEs shall be paged.

The request message may be a control plane message or a user plane message.

For example, the trigger request message may be a control plane message that is received from the MTC-IWF 400 e.g. over the T5b or T5c interface, or from the SCSF 500 e.g. over the Gi/SGi interface and then the Gn interface, or from the SGW 300 e.g. over the S11 interface, or a from P-GW.

For example, the trigger request message may be a user plane message that is received from the SGW 300 or a P-GW. The trigger request message may be received from the SGW or the PGW as a response to packet inspection of received downlink data performed by the SGW or the PGW respectively, where the downlink data comprises a group-trigger, e.g. a Differentiated Services Code Point (DSCP) or similar indicating that the particular group of UEs shall be paged.

The trigger request message may originate from the Application Server 600 (see FIG. 3), where the Application Server 600 has inserted a group-trigger into the trigger request message such that the group-trigger indicates to the MME 200 that the UEs in a particular group of UEs shall be paged. Alternatively, the Application Server 600 may insert a group-trigger into some other message that causes some other node or function to send the actual trigger request message comprising a group-trigger that indicates to the MME 200 that the UEs in a particular group of UEs shall be paged.

### Example Operation 422:

A seventh exemplifying operation performed in the MME 200 is determining, based on the trigger request comprising the group-trigger, that the group of UEs in the particular group of UEs identified by the group-trigger shall be paged.

In other words, the MME 200 is configured to operatively determine—based on the trigger request comprising the group-trigger—that the group of UEs shall be paged.

The MME 200 may be locally configured to perform this determining, e.g. being locally configured such that it will page the UEs in a certain group of UEs when it receives a predefined group-trigger—that identifies the particular group of UEs.

Alternatively, the MME 200 may be configured to obtain information about the group-trigger from other nodes or units. For example, the MME 200 may be configured to operatively obtain the group-trigger for the particular group of UEs from the HSS 700 or another node or unit such that the MME 200 is configured to page the UEs in the certain group of UEs when the MME 200 receives that group-trigger. The HSS 700 or similar node that receives such inquiries from the MME 200 may be configured to search in the subscription information or similar of one or more of the UEs in the particular group of UEs to find the group-trigger or similar information and then send it to the MME 200 enabling the MME 200 to configure itself to page the particular group of UEs when it receives a group-trigger identifying this group.

### Example Operation 423

An eighth exemplifying operation performed in the MME 200 is paging, as a response to the trigger request message, all the UEs in the group of UEs by sending one single paging message comprising the commonly allocated terminal-identity or at least the commonly allocated group-identity to each eNB serving one or more UEs in the group of UEs.

The paging message may e.g. be similar to the paging message defined in 3GPP TS 23.401 V13.2.0 (2015-03) clause 5.3.4.3 step 3a, except that the paging message of the present embodiment comprises a commonly allocated terminal-identity (e.g. GUTI) or at least a commonly allocate group-identity (e.g. S-TMSI or M-TMSI) where the terminal-identity or at least the group-identity is the same as the one that was commonly allocated for all UEs in the group of UEs in operation 413 above. The group-identity may e.g. correspond to the UE paging Identity mentioned in 3GPP TS 23.401 V13.2.0 (2015-03) clause 9.1.6.

It can be noted that a paging message comprising a commonly allocated S-TMSI or possibly a commonly allocated M-TMSI can be sent just as specified 3GPP TS 23.401 V13.2.0 (2015-03) clause 5.3.4.3 step 3a where the UE paging Identity is a S-TMSI as specified in 3GPP TS 23.401 V13.2.0 (2015-03) clause 9.1.6, but now commonly allocated for all UEs in the group of UEs. Thus, this first exemplifying embodiment has no impact on the UE as such, i.e. the UE can act as before unaffected of the new paging scheme of this first embodiment.

As indicated above under operation 413, it is preferred that the same common GUTI has been allocated for all UEs in the group of UEs. Alternatively, it is preferred that at least the same common M-TMSI and/or at least the same common S-TMSI has been is allocated for all the UEs in the group of UEs.

By using the same common GUTI or at least the same common S-TMSI or M-TMSI for all UEs in the group of UEs in the paging message sent to the eNB 110 it is possible for the MME 200 to page the whole group of UEs by a sending one single paging message to each eNB or similar that serves one or more UEs in the group of UEs. The same applies when common terminal-identities are used that are not a GUTI and when common group-identities are used that are not a S-TMSI or a M-TMSI. The advantage of using a single paging message for paging the whole group of UEs will be further discussed operation 424 below.

As a contrast, if a unique GUTI is used for each UE in the paging process—as in the paging message in 3GPP TS 23.401 V13.2.0 (2015-03) clause 5.3.4.3 step 3a—then one paging message has to be sent for each UE in the group of UEs to each individual eNB or similar RAN node serving that UE. This can easily amount to a large number of paging messages, especially since there may be many UEs in a group of UEs and since each of these UEs may be served or at least potentially served by several eNBs or similar, where each such eNB has to be paged for each such UE they serve or may potentially serve.

### Example Operation 424

A ninth exemplifying operation performed in the eNB 110 or similar RAN node serving one or more UEs in the group of UEs is paging all the UEs in the group of UEs. The paging is done by sending one single paging message comprising the allocated same common terminal-identity or at least the allocated same common group-identity to be received by all UEs in the group of UEs. The paging is done in response to the single paging message that was received in operation 423 above. The paging is done over the air interface between the RAN node eNB 110 and the UEs in the group of UEs.

The paging message may e.g. be similar to the paging message defined in 3GPP TS 23.401 V13.2.0 (2015-03) clause 5.3.4.3 step 4a, except that the single paging message of the present embodiment comprises the common terminal-identity (e.g. GUTI) and/or the common group-identity (e.g. S-TMSI or M-TMSI) that was allocated for each UE in the group of UEs in the allocating operation 413 and sent to each UE in the group of UEs in the connection accept operation 415. Since each UE in the group of UEs was configured with the same common GUTI in the connection accept operation 415, then all UEs in the group of UEs will respond to the single paging message of this operation 424 comprising the common GUTI. The same applies mutatis mutandis when all UEs are configured with the same common S-TMSI and the one single paging messages comprises the common S-TMSI, and when all UEs are configured the same common M-TMSI and the one single paging messages comprises the common M-TMSI.

As a contrast, if a unique GUTI is used for each UE in the paging process—as in the paging message in 3GPP TS 23.401 V13.2.0 (2015-03) clause 5.3.4.3 step 4a—then one paging message has to be sent to each UE in the group of UEs by each eNB serving the UE or potentially serving the UE in question. As already discussed under operation 423, this can easily amount to a large number of paging messages, especially since there may be many UEs in the group of UEs and since each UE may be served or at least potentially served by several eNBs.

### Service Request Based on the Common Part of the Group-Identity—Section 430

### Example Operation 431 and 432:

A tenth exemplifying operation performed in the MME 200 is receiving, from each UE in the group of UEs, a service request message comprising the same common terminal-identity and/or the same common group-identity. The service request message is received from each UE via the eNB serving the UE in question.

The service request messages may e.g. be similar to the NAS service request message defined in 3GPP TS 23.401 V13.2.0 (2015-03) clause 5.3.4.1 step 2, except that all the service request messages of the present embodiment comprises the same common terminal-identity (e.g. GUTI) and/or the same common group-identity (e.g. S-TMSI or M-TSMI) that is used for all UEs in the group of UEs, see operations 413 and 415 above.

Thus the MME 200 cannot easily separate a service request message received from UE1 from a request message received from UEn in the group of UEs, since both messages comprise the same common terminal-identity (e.g. the same GUTI) and/or the same common group-identity (e.g. the same S-TMSI or the same M-TSMI).

It is therefore preferred that the MME 200 obtains the unique identity of each paged UE in the group of UEs that has sent a service request. This is done in the next two operations 433 and 434 to be discussed in some detail below.

### Example Operations 433 and 434:

An eleventh exemplifying operation is performed in the MME 200 for each UE in the group of UEs for which the MME 200 has received a service request message. The eleventh exemplifying operation is sending to each such UE in the group of UEs a request for terminal identification, and receiving from each UE in the group of UEs the unique International Mobile Subscriber Identity (IMSI) comprised by the UE in question.

The sending and receiving in this operation can e.g. correspond to the sending of the identity request message and the receiving of the identity response message respectively as defined in 3GPP TS 23.401 V13.2.0 (2015-03) clause 5.3.2.1 step 4.

### Example Operations 435 and 436:

A twelfth exemplifying operation performed in the MME 200 is continuing the service request for each UE based on the unique IMSI received for each UE in the group of UEs in the previous operations 433 and 434.

The service request may e.g. be continue by a S1-AP Initial Context Setup Request as defined in 3GPP TS 23.401 V13.2.0 (2015-03) clause 5.3.4 step 4.

### GUTI Reallocation—Section 440

### Example Operations 441 and 442:

A thirteenth exemplifying operation may be performed in the MME 200 for an individual UE in the group of UEs for which an individual paging and an individual downlink service is desired or requested.

The thirteenth exemplifying operation is sending to the individual UE in the group of UEs a terminal-identity reallocation command message, and receiving from the UE a terminal-identity reallocation complete message comprising the unique terminal-identity of the UE, e.g. such as the unique IMSI or similar of the UE in question An individual paging is then possible for a downlink service based on the unique terminal-identity.

The sending and receiving in this operation can e.g. correspond to the sending of the GUTI Reallocation Command message and the receiving of the GUTI Reallocation Complete message respectively as defined in 3GPP TS 23.401 V13.2.0 (2015-03) clause 5.3.7 steps 1 and 2.

FIG. 5 is a signaling diagram depicting the operation of a second exemplifying embodiment of a method for paging a group of wireless terminals. The method is performed in a mobility management unit operatively configured to perform the paging method in a machine-type architecture, e.g. in the machine-type architecture shown in FIG. 3.

The second exemplifying method is described in some detail below with reference to a mobility management unit in the form of a MME 200, radio access network nodes (RAN nodes) in the form of eNBs and wireless terminals in the form of UEs. In FIG. 5 the group of wireless terminals is a group of UEs comprising UE1 to UEn. The mobility management unit may alternatively be a Serving GPRS Support Node (SGSN) or similar.

### Prepare MME and RAN-Nodes—Section 510

### Example Operation 511:

A first exemplifying operation performed in the MME 200 is receiving of a connection request message from each UE in the group of UEs.

In this embodiment it is preferred that the connection request message comprises a group-support indication indicating to the MME 200 that the UE in question supports group-paging based on a unique terminal-identity. The group-support indication enables the MME 200 to determine whether a particular UE in the group of UEs supports group-paging based on a unique terminal-identity. For example, the MME 200 may then refrain from paging the UEs in the group of UEs that do not support group-paging based on a unique terminal-identity.

The connection request message may e.g. be an attach request message or similar, e.g. an attach request message as specified in 3GPP TS 23.401 V13.2.0 (2015-03) clause 5.3.2 step 2, but with the addition that the attach request comprises a group-support indication.

### Example Operation 512:

A second exemplifying operation performed in the MME 200 is sending of a create session request message or similar, preferably to the SGW 300 or similar that is preferably selected by the MME 200. The create session request message may e.g. be a create session request message as specified in 3GPP TS 23.401 V13.2.0 (2015-03) clause 5.3.2 step 12.

### Example Operation 513:

A third exemplifying operation performed in the MME 200 is allocating a terminal-identity for each UE1 to UEn in the group of UEs. Each terminal-identity comprises a group-identity. In some embodiments the whole terminal-identity may be the group-identity while the group-identity may be a part of the terminal-identity in other embodiments. At least a part of the terminal-identity or at least a part of the group-identity is allocated to be the same for all UEs in the group of UEs. In addition, at least a part of the terminal-identity or at least a part of the group-identity is allocated to be unique for each UE in the group of UEs. This additional uniqueness is different compared to the first exemplifying embodiment described above with reference to FIG. 4.

In this embodiment it is preferred that the terminal-identity is a GUTI comprising a group-identity. It is preferred that the group-identity is a S-TMSI or a M-TMSI comprised by the GUTI. Here, it is preferred that a unique GUTI is allocated for each UE in the group of UEs such that the S-TMSI or the M-TMSI is allocated with one part that is the same for all UEs in the group of UEs and another part that is unique for each UE in the group of UEs.

For example, the MME 200 may allocate a unique GUTI having a unique M-TMSI by reserving the upper half of the M-TMSI for the common part and the lower half the M-TMSI for the unique part. The 32 bits of the M-TMSI gives a range from 00 00 00 00 to FF FF FF FF in hexadecimal format and the MME 200 may e.g. allocate a unique M-TMSI comprising two parts XX XX YY YY (e.g. C1 EE FF 01) for a particular UE, where XX XX (e.g. C1 EE) is the common part allocated for all UEs in the group of UEs while YY YY (e.g. FF 01) is the unique part allocated for a particular UE in the group of UEs. Of course, any other suitable reservation of the bits in the M-TMSI can be used if needed. The MME 200 can then use such a unique M-TMSI with a common part and a unique part to either page all the UEs in the group of UEs based on the common part XX XX of the M-TMSI or an individual UE in the group of UEs based on the unique part YY YY of the M-TMSI.

The use of a unique M-TMSI with a common part and a unique part to either page all the UEs in the group of UEs or an individual UE in the group of UEs based on the unique of the M-TMSI may require a paging-mask. The paging-mask may indicate to each UE in the group of UEs that the UE shall respond to paging messages which indicates that the paging is directed to the group of UEs. The paging-mask may e.g. be sent to each UE in the connection accept message of operation 515 and/or in the paging message of operation 523, see discussion below. Paging of individual UEs in the group of UEs can be done based on the unique M-TMSI or similar in any well-known manner and the paging-mask is preferably not used at such individual paging.

### Example Operation 514:

A fourth exemplifying operation performed in the MME 200 is receiving of a create session response message or similar from the SGW 300 or similar. The create session response message may e.g. be a create session response as specified in 3GPP TS 23.401 V13.2.0 (2015-03) clause 5.3.2 step 16.

### Example Operation 515:

A fifth exemplifying operation performed in the MME 200 is sending a connection accept message for each UE in the group of UEs. The connection accept message is sent in response to the connection request message received in operation 511. The connection accept message for a UE in the group of UEs comprises the unique terminal-identity that was allocated for the UE in the previous operation 513.

As discussed under operation 513 it is preferred that the terminal-identity is a GUTI comprising the group-identity, and that the group-identity correspond to a S-TMSI or M-TMSI or similar comprised by the GUTI.

The connection accept message may be similar to the attach accept message or initial context setup message specified in 3GPP TS 23.401 V13.2.0 (2015-03) clause 5.3.2 step 17, but now comprising an unique terminal-identity (e.g. GUTI) with a group-identity (e.g. S-TMSI or M-TMSI) for each UE in the group of UEs, such that at least a part of the terminal-identity or at least a part of the group-identity is the same for all UEs in the group of UEs, and at least a part of the terminal-identity or at least a part of the group-identity is unique for each UE in the group of UEs. In other words, this embodiment does not use a fully unique GUTI for each attaching UE as is the case in clause 5.3.2 step 17. Instead there is always a common part in the terminal-identity or at least in the group-identity that is the same for all UEs in the group of UEs.

By providing a GUTI or a S-TMSI or a M-TMSI with a common part that is the same to all UEs in the group of UEs it will be possible for the MME 200 to page the whole group of UEs by simply sending one single paging message to each eNB or similar RAN node that serves one or more UEs in the group of UEs. This saves paging messages, as will be discussed below in connection with operations 423 and 424. This also applies when common terminal-identities are used that are not a GUTI and when common group-identities are used that are not a S-TMSI or a M-TMSI.

In addition, by providing each UE in the group of UEs with a GUTI or at least a S-TMSI or a M-TMSI that has a part that is unique for the UE in question it will be possible for the MME 200 to page an individual UE using the full unique GUTI in the normal manner.

In some embodiments it is preferred that the connection accept message comprises a paging-mask. The paging-mask indicates to each UE in the group of UEs that the UE shall respond to paging messages that indicates that the paging is directed to the group of UEs. This enables all UEs in the group of UEs to separate a paging message directed to all UEs in the group of UEs from a paging message directed to an individual UE in the group of UEs.

The paging-mask may e.g. be a flag (e.g. represented by one or more bits) or similar that is set in the paging message to indicate that the paging is directed to all UEs in the group of UEs.

Alternatively, the paging-mask may e.g. indicate to each UE in the group of UEs that the paging is directed to all UEs in the group of UEs only when the unique part of the group-identity is set to a particular predetermined value. Here, it is preferred that the common part of the group-identity is the same (e.g. C1 EE hexadecimal, see example above under operation 513) when the group of UEs is paged and when an individual UE in the group of UEs is paged, while the unique part is set to a particular predetermined value (e.g. 00 00 hexadecimal) when the group of UEs is paged and to a unique value (e.g. FF 01 hexadecimal, see example above under operation 513) when a particular UE in the group is paged.

### Paging Whole UE Group—Section 520

### Example Operation 521:

A sixth exemplifying operation performed in the MME 200 is receiving a trigger request message comprising a group-trigger indicating that the particular group of UEs shall be paged.

The trigger request message may be any suitable message received in any suitable manner from any suitable node or unit or function, provided that trigger request message comprises a group-trigger that indicates to the MME 200 that the UEs in a particular group of UEs shall be paged.

However, it is preferred that the trigger request message is the same as or similar to the trigger request described above under operation 421.

### Example Operation 522:

A seventh exemplifying operation performed in the MME 200 is determining, based on the trigger request comprising the group-trigger, that the group of UEs in the particular group of UEs identified by the group-trigger shall be paged. It is preferred that this determining is the same as or similar to the determining described above under operation 422.

### Example Operation 523

An eighth exemplifying operation performed in the MME 200 is paging, as a response to the trigger request message, all the UEs in the group of UEs by sending one single paging message to each eNB serving one or more UEs in the group of UEs. The paging message comprises a terminal-identity or at least a group-identity, where the terminal-identity or at least the group-identity comprises a part that is the same as the part that was commonly allocated for all UEs in the group of UEs in operation 513 and 515 above.

The paging message may e.g. be similar to the paging message defined in 3GPP TS 23.401 V13.2.0 (2015-03) clause 5.3.4.3 step 3a, except that the paging message of the present embodiment comprises a terminal-identity (e.g. GUTI) or at least a group-identity (e.g. M-TSMI or S-TMSI) where the terminal-identity or at least the group-identity has a part that is the same as the part that was commonly allocated for all UEs in the group of UEs in operation 513 above. The group-identity may e.g. correspond to the UE paging Identity mentioned in 3GPP TS 23.401 V13.2.0 (2015-03) clause 9.1.6.

By using a GUTI or a S-TMSI or a M-TMSI with a part that is common for all UEs in the group of UEs in the paging message sent to the eNB 110 it is possible for the MME 200 to page the whole group of UEs by a sending one single paging message to each eNB or similar that serves one or more UEs in the group of UEs. The same applies when common terminal-identities are used that are not a GUTI and when common group-identities are used that are not a S-TMSI or a M-TMSI. The advantages of using a single paging message for paging the whole group of UEs were discussed under operations 423 and 424 above.

In some embodiments it is preferred that the paging message comprises a paging-mask. It is preferred that the paging-mask is the same as or similar to the paging-mask discussed above under operation 515.

### Example Operation 524

A ninth exemplifying operation performed in the eNB 110 or similar RAN node serving one or more UEs in the group of UEs is paging all the UEs in the group of UEs. The paging is done by sending one single paging message comprising a terminal-identity (GUTI) or at least a group-identity (M-TSMI, S-TMSI) comprising a part that was allocated to be the same for all UEs in the group of UEs in the allocating operation 513 above.

The paging message may e.g. be similar to the paging message defined in 3GPP TS 23.401 V13.2.0 (2015-03) clause 5.3.4.3 step 4a, except that the single paging message of the present embodiment comprises a part of the terminal-identity (e.g. GUTI) and/or a part of the group-identity (e.g. S-TMSI or M-TMSI) that was allocated to be the same for each UE in the group of UEs in the allocating operation 513 and sent to each UE in the group of UEs in the connection accept operation 515. Thus, since each UE in the group of UEs was configured in the connection accept operation 515 with a GUTI or at least a S-TMSI or a M-TMSI with a part that is the same for all UEs then all UEs in the group of UEs will be able to respond to the single paging message of this operation 524 comprising this same common part.

The advantages of using a single paging message for paging the whole group of UEs were discussed under operations 423 and 424 above.

In some embodiments it is preferred that the paging message in operation 524 comprises a paging-mask indicating to each UE in the group of UEs that the UE shall respond to paging messages indicating that the paging is directed to the group of UEs. The paging-message may have the same or similar contents as the paging-message of operation 523.

### Service Request Based on the Unique Part of the Group-Identity—Section 530

### Example Operation 531 and 532:

A tenth exemplifying operation performed in the MME 200 is receiving, from each UE in the group of UEs, a service request message comprising a group-identity (M-TSMI, S-TMSI) where least a part of the group-identity is unique for the UE in question. The service request message is received from each UE via the eNB serving the UE in question.

The service request messages may e.g. be similar to the NAS service request message defined in 3GPP TS 23.401 V13.2.0 (2015-03) clause 5.3.4.1 step 2, except that all the service request messages of the present embodiment comprises group-identity (e.g. S-TMSI or M-TSMI) that is unique for the UE in the group of UEs, see operations 513 and 515 above.

Thus the MME 200 can separate a service request message received from UE1 from a request message received from UEn in the group of UEs, since UE1 provides a group-identity (e.g. S-TMSI or M-TMSI) that is unique and thus different from the unique group-identity (e.g. S-TMSI or M-TMSI) provided by UEn.

### Example Operation 533:

An eleventh exemplifying operation performed in the MME 200 is continuing the service request for each UE in the group of UEs based on the unique group-identity (e.g. S-TMSI or M-TMSI) received for each UE in the previous operation 532.

The service request may e.g. be continue by a S1-AP Initial Context Setup Request as defined in 3GPP TS 23.401 V13.2.0 (2015-03) clause 5.3.4 step 4.

FIG. 9 illustrates an exemplifying mobility management unit 200 configured to operatively perform the operations of the exemplifying embodiments described herein. As shown in FIG. 9, the network gateway node may comprise a processor arrangement 910 and a memory arrangement 920. The processor arrangement is preferably configured to operatively communicate with other nodes and units illustrated in FIG. 3 and to operatively execute instructions stored in the memory arrangement. The memory arrangement comprises instructions executable by said processor arrangement such that the exemplifying network node is configured to perform the operations of the exemplifying embodiments described herein. The processor arrangement 910 may comprise any suitable digital and analogue circuitry that enables it to execute the instructions stored in the memory arrangement so as to perform the operations and functions of the exemplifying embodiments described herein. The digital and analogue circuitry of the processor arrangement 910 and the memory arrangement 920 may e.g. be the same or similar as those in known mobility management nodes such as a MME or a SGSN or similar, whereas the instructions are specific for the embodiment described herein.

FIG. 10 illustrates an exemplifying wireless terminal 800 configured to operatively perform the operations of the exemplifying embodiments described herein. As shown in FIG. 10, the wireless terminal may comprise a processor arrangement 810 and a memory arrangement 820. The processor arrangement is preferably configured to operatively communicate with various RAN nodes, e.g. as illustrated in FIG. 3 and to operatively execute instructions stored in the memory arrangement. The memory arrangement comprises instructions executable by said processor arrangement such that the exemplifying network node is configured to perform the operations of the exemplifying embodiments described herein. The processor arrangement 810 may comprise any suitable digital and analogue circuitry that enables it to execute the instructions stored in the memory arrangement so as to perform the operations and functions of the exemplifying embodiments described herein. The digital and analogue circuitry of the processor arrangement 810 and the memory arrangement 820 may e.g. be the same or similar as those in known wireless terminals such as an UE or similar, whereas the instructions are specific for the embodiment described herein.

Some embodiments described above may be summarized in the following manner:

One embodiment is directed to a method for paging a group of wireless terminals served by one or more radio access network nodes. The method is performed by a mobility management unit and comprises:
receiving for each wireless terminal in the group of wireless terminals a connection request message,
allocating for each wireless terminal in the group of wireless terminals a terminal identity (e.g. GUTI) with a group identity (e.g. M-TSMI or S-TMSI) where the terminal identity or at least the group identity is the same or at least partly the same for each wireless terminal,
sending to each wireless terminal in the group of wireless terminals, in response to the connection request message, a connection accept message comprising the terminal identity to enable paging the group of wireless terminals by a single paging message to each radio access network node serving one or more wireless terminals in the group of wireless terminals.

The connection accept message may comprise a paging-mask indicating to the wireless terminals in the group of wireless terminals that the wireless terminal shall respond to a paging message indicating that the paging is directed to the group of wireless terminals. The paging-mask enables all wireless terminals in the group of wireless terminals to separate a paging message directed to all wireless terminals in the group of wireless terminals from a paging message directed to an individual wireless terminal in the group of wireless terminals.

The method may further comprise:
receiving a trigger request message comprising a group trigger indicating that the group of wireless terminals shall be paged,
paging, as a response to receiving the trigger request, the whole group of wireless terminals by sending a single paging message comprising the part of the terminal identity (e.g. GUTI) or the part of the group identity (e.g. M-TSMI or S-TMSI) that is allocated the same for each wireless terminal to each radio access network node serving one or more wireless terminals in the group of wireless terminals.

The paging message may comprise a paging-mask indicating to the wireless terminals in the group of wireless terminals that the wireless terminal shall respond to the paging message indicating that the paging is directed to the group of wireless terminals. The paging-mask enables all wireless terminals in the group of wireless terminals to separate a paging message directed to all wireless terminals in the group of wireless terminals from a paging message directed to an individual wireless terminal in the group of wireless terminals.

The method may further comprise:
receiving from each wireless terminal in the group of wireless terminals a service request message comprising the terminal identity (e.g. GUTI) or at least the group identity (e.g. M-TSMI or S-TMSI),
sending to each wireless terminal in the group of wireless terminals a request for terminal identification,
receiving from each wireless terminal an international mobile subscriber identity, IMSI, and
continuing the service request for each wireless terminal based on its IMSI.

The group identity (e.g. M-TSMI or S-TMSI) may have a part that is the same for all wireless terminals and a part that is unique for each wireless terminal.

The method may further comprise:
receiving from each wireless terminal in the group of wireless terminals a service request message comprising the part of the group identity (e.g. M-TSMI or S-TMSI) that is unique for the wireless terminal,
continuing the service request for each wireless terminal based on the part of the group identity (e.g. M-TSMI or S-TMSI) that is unique for the wireless terminal.

The trigger request message may be a control plane message or a user plane message.

The trigger request message may be a control plane message that is received from a machine type communication inter working function, MTC IWF or a service capability server function, SCSF or a serving gateway, SGW or a packet data network gateway, PGW.

The trigger request message may be a user plane message that is received from a serving gateway, SGW or a packet data network gateway, PGW.

The trigger request message may be downlink data notification, DDN, message.

The trigger request message may be received from the SGW or the PGW as a response to packet inspection of received downlink data by the SGW or the PGW respectively where the downlink data comprises a triggering code, e.g. a differentiated services code point DSCP.

The terminal identity may be a globally unique temporary identity, GUTI, and the group identity is a SAE temporary mobile subscriber identity, S-TSMI, or a MME temporary mobile subscriber identity, M-TMSI.

Some other embodiments described above may be summarized in the following manner:

One other embodiment is directed to a method for receiving paging of a group of wireless terminals served by a radio access network node. The method is performed by a wireless terminal of the group of wireless terminals and comprises:
sending a connection request message,
receiving, in response to the connection request message, a connection accept message comprising a terminal identity (e.g. GUTI) with a group identity (e.g. M-TSMI or S-TMSI) where the group identity has a part that is the same for all wireless terminals in the group of wireless terminals and a part that is unique for each wireless terminal in the group of wireless terminals.

The connection accept message may comprise a paging-mask indicating to the wireless terminals that it shall respond to a paging message indicating that the paging is directed to the group of wireless terminals.

The method may further comprise:

receiving a paging message at least comprising the part of the group identity (S TMSI, M TMSI) that is the same for all wireless terminals in the group of wireless terminals from the radio access network node serving the wireless terminal.

The paging message may comprise a paging-mask indicating to the wireless terminals in the group of wireless terminals that the wireless terminal shall respond to the paging message indicating that the paging is directed to the group of wireless terminals.

The method may further comprise:

sending a service request message comprising the part of the group identity (e.g. M-TSMI or S-TMSI) that is unique for the wireless terminal. The service request message is sent to the radio access node serving the wireless terminal.

The terminal identity may be a globally unique temporary identity, GUTI, and the group identity may be a SAE temporary mobile subscriber identity, S-TSMI, or a MME temporary mobile subscriber identity, M-TMSI.

Some other embodiments described above may be summarized in the following manner:

One other embodiment is directed to a mobility management unit for paging a group of wireless terminals served by one or more radio access network nodes. The mobility management unit comprises a memory with instructions and a processor configured to operatively execute the instructions to:
receive for each wireless terminal in the group of wireless terminals a connection request message,
allocate for each wireless terminal in the group of wireless terminals a terminal identity (e.g. GUTI) with a group identity (e.g. M-TSMI or S-TMSI) where the terminal identity or at least the group identity is the same or at least partly the same for each wireless terminal,
send to each wireless terminal in the group of wireless terminals, in response to the connection request message, a connection accept message comprising the terminal identity to enable paging the group of wireless terminals by a single paging message to each radio access network node serving one or more wireless terminals in the group of wireless terminals.

The connection accept message may comprise a paging-mask indicating to the wireless terminals in the group of wireless terminals that the wireless terminal shall respond to a paging message indicating that the paging is directed to the group of wireless terminals.

The memory may comprise further instructions while the processor is configured to operatively execute theses instructions to:
receive a trigger request message comprising a group trigger indicating that the group of wireless terminals shall be paged,
page, as a response to receiving the trigger request, the whole group of wireless terminals by sending a single paging message comprising the part of the terminal identity (e.g. GUTI) or the part of the group identity (e.g. M-TSMI or S-TMSI) that is allocated the same for each wireless terminal to each radio access network node serving one or more wireless terminals in the group of wireless terminals.

The paging message may comprise a paging-mask indicating to the wireless terminals in the group of wireless terminals that the wireless terminal shall respond to the paging message indicating that the paging is directed to the group of wireless terminals.

The memory may comprise further instructions while the processor is configured to operatively execute these instructions to:
receive from each wireless terminal in the group of wireless terminals a service request message comprising the terminal identity (e.g. GUTI) or at least the group identity (e.g. M-TSMI or S-TMSI),
send to each wireless terminal in the group of wireless terminals a request for terminal identification,
receive from each wireless terminal an international mobile subscriber identity, IMSI, and
continue the service request for each wireless terminal based on its IMSI.

The group identity (e.g. S-TMSI or M-TMSI) may have a part that is the same for all wireless terminals and a part that is unique for each wireless terminal.

The memory may comprise further instructions while the processor is configured to operatively execute these instructions to:
receive from each wireless terminal in the group of wireless terminals a service request message comprising the part of the group identity (e.g. S-TMSI or M-TMSI) that is unique for the wireless terminal,
continue the service request for each wireless terminal based on the part of the group identity (e.g. S-TSIM or M-TMSI) that is unique for the wireless terminal.

The trigger request message may be a control plane message or a user plane message.

The trigger request message may be a control plane message that is received from a machine type communication inter working function, MTC IWF or a service capability server function, SCSF or a serving gateway, SGW or a packet data network gateway, PGW.

The trigger request message may be a user plane message that is received from a serving gateway, SGW or a packet data network gateway, PGW.

The trigger request message may be a downlink data notification, DDN, message.

The trigger request message may be received from the SGW or the PGW as a response to packet inspection of received downlink data by the SGW or the PGW respectively where the downlink data comprises a triggering code, e.g. a differentiated services code point DSCP.

The terminal identity may be a globally unique temporary identity, GUTI, and the group identity may be a SAE temporary mobile subscriber identity, S-TSMI, or a MME temporary mobile subscriber identity, M-TMSI.

Some other embodiments described above may be summarized in the following manner:

One other embodiment is directed to a wireless terminal for receiving paging of a group of wireless terminals served by a radio access network node. The wireless terminal comprises a memory with instructions and a processor configured to operatively execute the instructions to:
send a connection request message,
receive, in response to the connection request message, a connection accept message comprising a terminal identity (e.g. GUTI) with a group identity (e.g. M-TSMI or S-TMSI) where the group identity has a part that is the same for all wireless terminals in the group of wireless terminals and a part that is unique for each wireless terminal in the group of wireless terminals.

The connection accept message may comprise a paging-mask indicating to the wireless terminals that it shall respond to a paging message indicating that the paging is directed to the group of wireless terminals.

The memory may comprise further instructions while the processor is configured to operatively execute these instructions to:

receive a paging message at least comprising the part of the group identity (e.g. M-TSMI or S-TMSI) that is the same for all wireless terminals in the group of wireless terminals from the radio access network node serving the wireless terminal.

The paging message may comprise a paging-mask indicating to the wireless terminals in the group of wireless terminals that the wireless terminal shall respond to the paging message indicating that the paging is directed to the group of wireless terminals.

The memory may comprise further instructions while the processor is configured to operatively execute these instructions to:

send a service request message comprising the part of the group identity (e.g. M-TSMI or S-TMSI) that is unique for the wireless terminal.

The terminal identity may be a globally unique temporary identity, GUTI, and the group identity may be a SAE temporary mobile subscriber identity, S TSMI, or a MME temporary mobile subscriber identity, M TMSI.

The foregoing description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. The features of the embodiments described herein may be combined in all possible combinations of methods, apparatus, modules, systems, and computer program products. It should be appreciated that any of the example embodiments presented herein may be used in conjunction, or in any combination, with one another.

It should be noted that the word “comprising” does not necessarily exclude the presence of other elements or steps than those listed and the words “a” or “an” preceding an element do not exclude the presence of a plurality of such elements. It should further be noted that any reference signs do not limit the scope of the example embodiments, that the example embodiments may be implemented at least in part by means of both hardware and software, and that several “means”, “units” or “devices” may be represented by the same item of hardware.

1. A method for paging a group of wireless terminals served by one or more radio access network nodes, the method performed by a mobility management unit comprises:
receiving for each wireless terminal in the group of wireless terminals a connection request message,
allocating for each wireless terminal in the group of wireless terminals a terminal-identity with a group-identity where the terminal-identity or at least the group-identity is the same or at least partly the same for each wireless terminal,
sending, to each wireless terminal in the group of wireless terminals, in response to the connection request message, a connection accept message comprising the terminal-identity to enable paging the group of wireless terminals by a single paging message to each radio access network node serving one or more wireless terminals in the group of wireless terminals.

2. The method according to claim 1, wherein the connection accept message comprises a paging-mask indicating to the wireless terminals in the group of wireless terminals that the wireless terminal shall respond to a paging message indicating that the paging is directed to the group of wireless terminals.

3. The method according to claim 1, further comprising:
receiving a trigger request message comprising a group-trigger indicating that the group of wireless terminals shall be paged,
paging, as a response to receiving the trigger request, the whole group of wireless terminals by sending a single paging message comprising the part of the terminal-identity or the part of the group-identity that is allocated the same for each wireless terminal to each radio access network node serving one or more wireless terminals in the group of wireless terminals.

4. The method according to claim 3, wherein the paging message comprises a paging-mask indicating to the wireless terminals in the group of wireless terminals that the wireless terminal shall respond to the paging message indicating that the paging is directed to the group of wireless terminals.

5. The method according to claim 3, further comprising:
receiving from each wireless terminal in the group of wireless terminals a service request message comprising the terminal-identity or at least the group-identity,
sending to each wireless terminal in the group of wireless terminals a request for terminal identification,
receiving from each wireless terminal an international mobile subscriber identity, IMSI, and
continuing the service request for each wireless terminal based on its IMSI.

6. The method according to claim 1, wherein the group-identity has a part that is the same for all wireless terminals and a part that is unique for each wireless terminal.

7. The method according to claim 6, further comprising:
receiving from each wireless terminal in the group of wireless terminals a service request message comprising the part of the group-identity that is unique for the wireless terminal,
continuing the service request for each wireless terminal based on the part of the group-identity that is unique for the wireless terminal.

8. The method according to claim 3, wherein the trigger request message is a control plane message or a user plane message.

9. The method according to claim 8, wherein the trigger request message is a control plane message that is received from a machine type communication inter working function, MTC-IWF or a service capability server function, SCSF or a serving gateway, SGW or a packet data network gateway, PGW.

10. The method according to claim 8, wherein the trigger request message is a user plane message that is received from a serving gateway, SGW or a packet data network gateway, PGW.

11. The method according to claim 8, wherein the trigger request message is a downlink data notification, DDN, message.

12. The method according to claim 8, wherein the trigger request message is received from the SGW or the PGW as a response to packet inspection of received downlink data by the SGW or the PGW respectively where the downlink data comprises a triggering code, e.g. a differentiated services code point DSCP.

13. The method according to claim 1, wherein the terminal-identity is a globally unique temporary identity, GUTI, and the group-identity is a SAE temporary mobile subscriber identity, S-TSMI, or a MME temporary mobile subscriber identity, M-TMSI.

14. A method for receiving paging of a group of wireless terminals served by a radio access network node, the method performed by a wireless terminal of the group of wireless terminals comprises:
sending a connection request message,
receiving, in response to the connection request message, a connection accept message comprising a terminal-identity with a group-identity where the group-identity has a part that is the same for all wireless terminals in the group of wireless terminals and a part that is unique for each wireless terminal in the group of wireless terminals.

15. The method according to claim 14, wherein the connection accept message comprises a paging-mask indicating to the wireless terminals that it shall respond to a paging message indicating that the paging is directed to the group of wireless terminals.

16. The method according to any one of claim 14, further comprising:
receiving a paging message at least comprising the part of the group-identity that is the same for all wireless terminals in the group of wireless terminals from the radio access network node serving the wireless terminal.

17. The method according to claim 16, wherein the paging message comprises a paging-mask indicating to the wireless terminals in the group of wireless terminals that the wireless terminal shall respond to the paging message indicating that the paging is directed to the group of wireless terminals.

18. The method according to claim 16, further comprising:
sending a service request message comprising the part of the group-identity that is unique for the wireless terminal.

19. The method according to claim 14 wherein the terminal-identity is a globally unique temporary identity, GUTI, and the group-identity is a SAE temporary mobile subscriber identity, S-TSMI, or a MME temporary mobile subscriber identity, M-TMSI.

20. A mobility management unit for paging a group of wireless terminals served by one or more radio access network nodes, where the mobility management unit comprises a memory with instructions, and a processor configured to operatively execute the instructions to:
receive for each wireless terminal in the group of wireless terminals a connection request message,
allocate for each wireless terminal in the group of wireless terminals a terminal-identity with a group-identity where the terminal-identity or at least the group-identity is the same or at least partly the same for each wireless terminal,
send to each wireless terminal in the group of wireless terminals, in response to the connection request message, a connection accept message comprising the terminal-identity to enable paging the group of wireless terminals by a single paging message to each radio access network node serving one or more wireless terminals in the group of wireless terminals.

21. The mobility management unit according to claim 20, wherein the connection accept message comprises a paging-mask indicating to the wireless terminals in the group of wireless terminals that the wireless terminal shall respond to a paging message indicating that the paging is directed to the group of wireless terminals.

22. The mobility management unit according to claim 20, where the memory comprises instructions and the processor is configured to operatively execute the instructions to:
receive a trigger request message comprising a group-trigger indicating that the group of wireless terminals shall be paged,
page, as a response to receiving the trigger request, the whole group of wireless terminals by sending a single paging message comprising the part of the terminal-identity or the part of the group-identity that is allocated the same for each wireless terminal to each radio access network node serving one or more wireless terminals in the group of wireless terminals.

23. The mobility management unit according to claim 22, wherein the paging message comprises a paging-mask indicating to the wireless terminals in the group of wireless terminals that the wireless terminal shall respond to the paging message indicating that the paging is directed to the group of wireless terminals.

24. The mobility management unit according to claim 22, where the memory comprises instructions and the processor is configured to operatively execute the instructions to:
receive from each wireless terminal in the group of wireless terminals a service request message comprising the terminal-identity or at least the group-identity,
send to each wireless terminal in the group of wireless terminals a request for terminal identification,
receive from each wireless terminal an international mobile subscriber identity, IMSI, and
continue the service request for each wireless terminal based on its IMSI.

25. The mobility management unit according to claim 20, wherein the group-identity has a part that is the same for all wireless terminals and a part that is unique for each wireless terminal.

26. The mobility management unit according to claim 25, where the memory comprises instructions and the processor is configured to operatively execute the instructions to:
receive from each wireless terminal in the group of wireless terminals a service request message comprising the part of the group-identity that is unique for the wireless terminal,
continue the service request for each wireless terminal based on the part of the group-identity that is unique for the wireless terminal.

27. The mobility management unit according to claim 22, wherein the trigger request message is a control plane message or a user plane message.

28. The mobility management unit according to claim 27, wherein the trigger request message is a control plane message that is received from a machine type communication inter working function, MTC-IWF or a service capability server function, SCSF or a serving gateway, SGW or a packet data network gateway, PGW.

29. The mobility management unit according to claim 27, wherein the trigger request message is a user plane message that is received from a serving gateway, SGW or a packet data network gateway, PGW.

30. The mobility management unit according to claim 27, wherein the trigger request message is a downlink data notification, DDN, message.

31. The mobility management unit according to claim 27, wherein the trigger request message is received from the SGW or the PGW as a response to packet inspection of received downlink data by the SGW or the PGW respectively where the downlink data comprises a triggering code, e.g. a differentiated services code point DSCP.

32. The mobility management unit according to claim 20, wherein terminal-identity is a globally unique temporary identity, GUTI, and the group-identity is a SAE temporary mobile subscriber identity, S-TSMI, or a MME temporary mobile subscriber identity, M-TMSI.

33. A wireless terminal for receiving paging of a group of wireless terminals served by a radio access network node, where the wireless terminal comprises a memory with instructions, and a processor configured to operatively execute the instructions to:
send a connection request message,
receive, in response to the connection request message, a connection accept message comprising a terminal-identity with a group-identity where the group-identity has a part that is the same for all wireless terminals in the group of wireless terminals and a part that is unique for each wireless terminal in the group of wireless terminals.

34. The wireless terminal according to claim 33, wherein the connection accept message comprises a paging-mask indicating to the wireless terminals that it shall respond to a paging message indicating that the paging is directed to the group of wireless terminals.

35. The wireless terminal according to claim 33, where the memory comprises instructions and the processor is configured to operatively execute the instructions to:
receive a paging message at least comprising the part of the group-identity that is the same for all wireless terminals in the group of wireless terminals from the radio access network node serving the wireless terminal.

36. The wireless terminal according to claim 35, wherein the paging message comprises a paging-mask indicating to the wireless terminals in the group of wireless terminals that the wireless terminal shall respond to the paging message indicating that the paging is directed to the group of wireless terminals.

37. The wireless terminal according to claim 35, where the memory comprises instructions and the processor is configured to operatively execute the instructions to:
send a service request message comprising the part of the group-identity that is unique for the wireless terminal.

38. The wireless terminal according to claim 33, wherein terminal-identity is a globally unique temporary identity, GUTI, and the group-identity is a SAE temporary mobile subscriber identity, S-TSMI, or a MME temporary mobile subscriber identity, M-TMSI.
